(19) United States
(12) Patent Application Publication
(10) Pub. No.: US 2005/0078082 A1
(43) Pub. Date: Apr. 14, 2005

(54) Method and apparatus for selectively blocking remote action

(76) Inventors: Girish Kumar Muralidharan, Pewaukee, WI (US); David Matthew Deaven, Delafield, WI (US)

Correspondence Address: Patrick S. Yoder;FLETCHER YODER, P.O. Box 692289, Houston, TX, 77269-2289, US

(21) Appl. No.: 10/681,730

(22) Filed: Oct. 8, 2003

(51) Int. Cl. G09G 5/00

(52) U.S. Cl. 345/156

(57) ABSTRACT

A technique is provided for limiting the information transmitted between a remote operator workstation and a medical imaging system. In the present technique, one or more interface regions of the displayed user interface are designated with one or more levels of remote access. The designated interface regions of the user interface may then be displayed remotely in a manner corresponding to their designation. For example, interface regions designated at one level may not be legibly displayed remotely but may instead be replaced a solid block on the remote operator workstation. Similarly, interface regions designated at a different level may be displayed remotely with a visual indicator, such as shading, color, tinting, hatching, and so forth, to indicate that the corresponding function is unavailable for remote use. Similarly, the present technique allows inputs from the remote operator workstation to be filtered to remove commands or instructions originating from an interaction with an interface region designated as unavailable for remote use.

### BACKGROUND OF THE INVENTION

The present invention relates generally to the remote configuration and observation of a mechanical and/or radiological system. More specifically, the present invention relates to the remote configuration and or servicing of a medical imaging system while retaining local control of the movement and/or operation of the system.

A wide variety of medical imaging technologies, such as digital X-ray, tomosynthesis, X-ray mammography, computed tomography (CT), positron emission tomography (PET), electron beam tomography (EBT), magnetic resonance imaging (MRI), and so forth, have become commonplace at both large and small medical facilities. Though the number of imaging systems associated with these technologies has steadily increased, the number of personnel qualified to service these systems or to instruct new technicians in their use has not increased at the same rate. Furthermore, because medical imaging systems have become more commonplace at rural or less centralized locations, it may be costly to support a service or instructional infrastructure composed of traveling technicians or instructors.

One alternative is to allow engineers and/or instructors to interact with imaging systems and facility personnel remotely. In this manner, travel time and costs associated with servicing remote, or even local, medical facilities may be reduced or eliminated. For example, a remote engineer may access the imaging system to perform diagnostic routines, to configure the settings used to acquire an image, to view problem images generated by facility personnel, and so forth. Similarly, a remote instructor may access the imaging system to demonstrate the settings appropriate for particular patient conditions or to demonstrate the effect of varying particular system settings in response to image irregularities or artifacts.

This alternative may be unacceptable, however, due to problems associated with remote access to the imaging system. For example, a remote engineer or instructor may be able to see the user interface for the imaging system remotely, but will not be able to see the imaging device or scanner itself or the location of patients or facility personnel in relation to the device or scanner. As a result, a remote engineer or instructor may improperly move a component of the imaging system, such as a CT table or gantry, or initiate the emission of radiation or the generation of a magnetic field when the patient or personnel are not properly positioned. It is therefore desirable to allow remote servicing and instruction to be performed on a medical imaging system while limiting the possibility of remote movement or operation of the system.

### BRIEF DESCRIPTION OF THE INVENTION

The present invention relates generally to providing a limited interface to remote service engineers and/or instructors to allow remote action on a medical imaging system or other system. In particular, the technique provides for partially or completely masking portions of the system interface which the remote operator may not operate or does not need to see. In addition, actions taken by the remote operator in the prohibited or limited portions of the interface may be filtered upon transmission to the system, thereby preventing inadvertent or intentional execution of a limited or prohibited action. In this manner, information that the remote operator does not for service or instructional purposes, such as private patient information, may be masked from the remote operator. Similarly, the remote operator may be prevented from taking actions reserved to a local operator who can visually oversee the procedure. For example, actions such as moving components of the imaging system, initiating radiation emissions, and/or generating powerful magnetic fields may be reserved for a local operator.

In accordance with one aspect of the present technique, a method for limiting remote display of a local system user interface is provided. One or more interface regions of a system user interface may be designated as limited remote access interface regions. The limited remote access interface regions present in screen data sent to a remote operator workstation for display may be modified such that, when displayed, they visually differ from respective unmodified interface regions. The modified interface regions may be displayed at the remote operator workstation for viewing by a remote operator. Systems and computer programs that afford functionality of the type defined by this method are also provided by the present technique.

### BRIEF DESCRIPTION OF THE DRAWINGS

The foregoing and other advantages and features of the invention will become apparent upon reading the following detailed description and upon reference to the drawings in which:

FIG. 1 is a general diagrammatical representation of certain functional components of an exemplary generic imaging system configured for remote operation via the present technique;

FIG. 2 is a block diagram depicting the various components of a limited remote access system in accordance with the present technique;

FIG. 3 is an exemplary local screen for use in accordance with the present technique;

FIG. 4 is an exemplary remote screen for use in accordance with the present technique;

FIG. 5 is a general diagrammatical representation of certain functional components of an exemplary CT imaging system in accordance with the present technique; and

FIG. 6 is a general diagrammatical representation of certain functional components of an exemplary MRI imaging system in accordance with the present technique.

### DETAILED DESCRIPTION OF SPECIFIC EMBODIMENTS

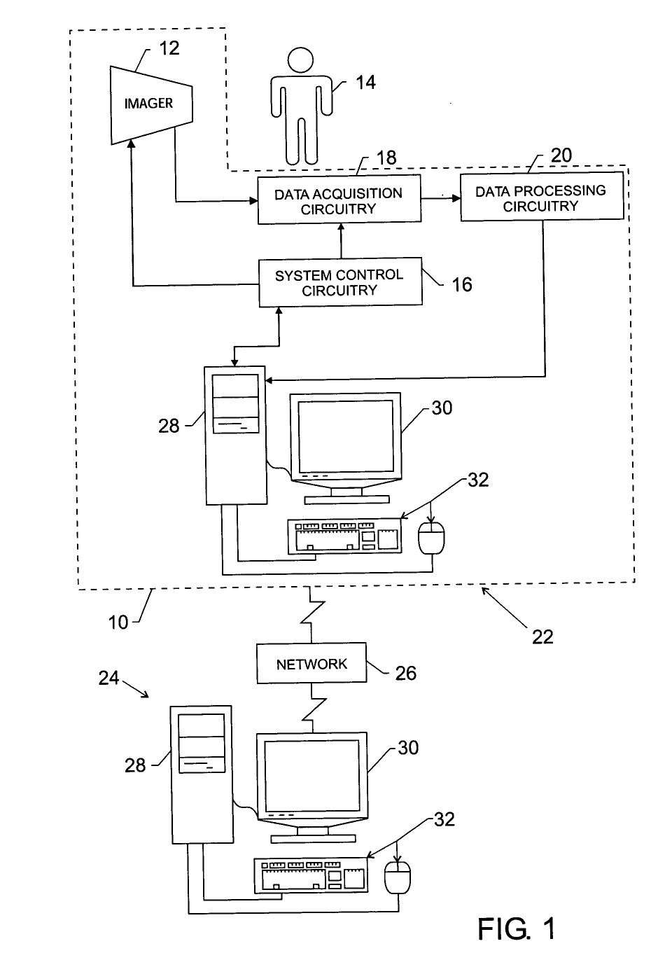

Turning now to the drawings, and referring first to FIG. 1, an exemplary medical imaging system 10 is depicted. Such systems are typically complex and require periodic maintenance of the system 10 and/or periodic instruction of the technicians or personnel using the system 10. The a vailability of qualified service engineers and/or instructors may be limited, however. The limited numbers of qualified personnel and the prevalence of the imaging systems 10 may, therefore, make remote service or instruction desirable where possible. However, it may also be desirable to limit the possible actions such a remote operator is allowed to perform, such as to prevent remote actions leading to the motion of moving components, the emission of X-rays, and/or the generation of strong magnetic fields. These various factors, alone or in combination, contribute to the challenges posed by remote operation of many types of medical imaging systems 10.

Such challenges are addressed in the present technique. In accordance with aspects of the technique, a remote operator, such as a service engineer and/or instructor, may be provided with a limited visual interface and/or a limited input interface. In this manner, the remote operator is only presented with information or options corresponding to the desired scope of the remote task.

For example, returning to FIG. 1, an exemplary medical imaging system 10 is depicted. Generally the imaging system 10 includes some type of imager 12 that detects signals and converts the signals to useful data. As described more fully below, the imager 12 may operate in accordance with various physical principles for creating the image data. In general, however, the imager 12 creates image data indicative of regions of interest in a patient 14 either in a conventional support, such as photographic film, or in a digital medium.

The imager 12 operates under the control of system control circuitry 16. The system control circuitry 16 may include a wide range of circuits, such as radiation source control circuits, timing circuits, circuits for coordinating data acquisition in conjunction with patient or table movements, circuits for controlling the position of radiation sources and detectors, and so forth. In the present context, the system control circuitry 16 may also include memory elements for storing programs and routines executed by the system control circuitry 16 or by associated components of the system 10.

The imager 12, following acquisition of the image data or signals, may process the signals, such as for conversion to digital values, and forward the image data to data acquisition circuitry 18. In the case of analog media, such as photographic film, the data acquisition system may generally include supports for the film, a swell as equipment for developing the film and producing hard copies that may be subsequently digitized. For digital systems, the data acquisition circuitry 18 may perform a wide range of initial processing functions, such as adjustment of digital dynamic ranges, smoothing or sharpening of data, as well as compiling of data streams and files, where desired. The data may then be transferred to data processing circuitry 20 where additional processing and analysis are performed. For conventional media such as photographic film, the data processing system may apply textual information to films, as well as attach certain notes or patient-identifying information. For the various digital imaging systems available, the data processing circuitry 20 perform substantial analyses of data, ordering of data, sharpening, smoothing, feature recognition, and so forth. The acquired images or image data may be stored in short or long-term storage devices, such as picture archiving communication systems, which may be comprised within or remote from the imaging system 10.

The above-described operations and functions of the imaging system 10 may be controlled by a local operator workstation 22, which typically interfaces with the system control circuitry 16. The local operator workstation 22 may include one or more general purpose or application specific computers 28 or processor-based components. The local operator workstation 22 may include a monitor 30 or other visual display and one or more input devices 32. The monitor 30 and input devices 32 may be used for viewing and inputting configuration information or for operating the imaging system 10, in accordance with the techniques discussed herein. As with the system control circuitry 16, the local operator interface station 22 may comprise or communicate with a memory or data storage component for storing programs and routines executed by the local interface station 22 or by associated components of the system 10. It should be understood that any type of computer accessible memory or storage device capable of storing the desired amount of data and/or code may be accessed by the local operator workstation 22. Moreover, the memory or storage device may comprise one or more memory devices, such as magnetic or optical devices, of similar or different types, which may be local and/or remote to the system 10.

It should be noted that more than a single local operator workstation 22 may be provided. For example, an imaging scanner or station may include an interface which permits regulation of the parameters involved in the image data acquisition procedure, whereas a different operator interface may be provided for manipulating, enhancing, and viewing resulting reconstructed images.

In addition, a remote operator workstation 24 may communicate with the imaging system 10, such as via a network 26. The network 26 may be a local intranet within the medical facility, a service network between the facility and a service provider, a direct communication line between the imaging system 10 and the remote workstation 24, a virtual private network established over the Internet, the Internet itself, and so forth. In general, the network 26 allows data exchange between the remote workstation 24 and one or more components of the imaging station 10. As will be appreciated by those skilled in the art, any suitable circuitry, such as modems, servers, firewalls, VPN's and so forth may be included within the network 26.

The remote operator workstation 24 comprises many, if not all, of the components of the local operator workstation 22, such as a monitor 30 and input devices 32. The remote operator workstation 24 allows a remote operator to access elements of the imaging station 10 via the network 26. In particular, the remote operator workstation 24 may allow a remote operator to configure parameters associated with a scanning operation, to access or initiate service operations, to configure the processing of acquired scan data, and so forth.

However, it may be desirable to limit the access allowed a remote operator. In particular, because a remote operator cannot visually monitor the physical location of the imaging system 10, it may be desirable to prevent the remote operator from taking actions affecting the site. For example, absent some mechanism for visual monitoring, it may be desirable to prevent a remote operator from moving components of the imaging system 10, such as tables, gantries, mechanical arms, and so forth, and from generating radiation or magnetic fields at the site. Similarly, it may be desirable to limit the patient data provided to a remote operator to data relevant to the remote operation. For example, a service engineer or instructor who is assisting in a patient scan may need to know certain medically relevant facts to facilitate the procedure. However, other information, such as patient name, unrelated medical history, demographic information, billing information, insurance, and so forth, may be irrelevant to the functions performed by the remote operator.

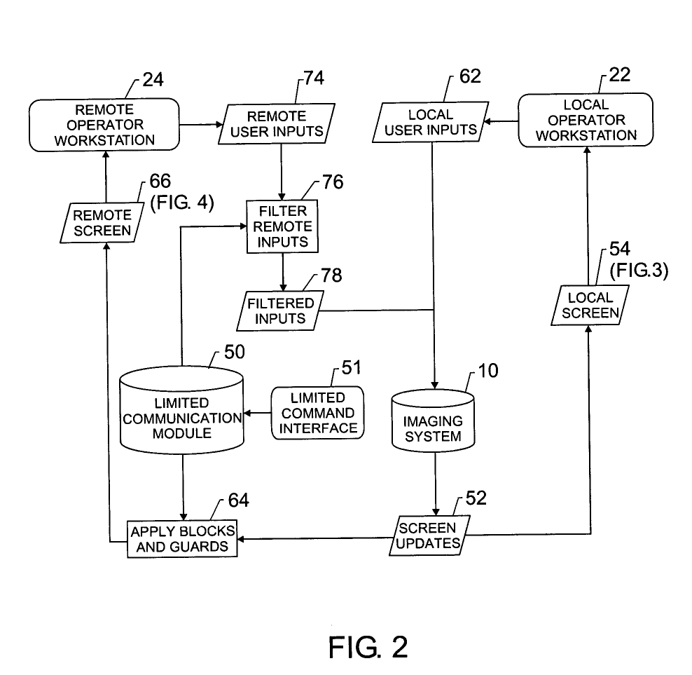

It may therefore be desirable to include a limited communication module 50 to monitor and/or modify communication between the remote operator workstation 24 and the imaging station 10, as depicted in FIG. 2. The limited communication module 50 may comprise one or more routines executed by a portion of the network 26 or by the imaging system 10. For example, the limited communication module 50 may comprise one or more routines run on a server or component of the network 26 which is in the communications path between the remote interface station 24 and the imaging station 10. Similarly, the limited communication module 50 may comprise one or more routines run on one or more components of the imaging station 10 which are in the communication path to the remote interface station 24, such as the local interface station 22 or the system control circuitry 16. Indeed, the routines comprising the limited communication module 50 may even be stored and executed on the remote interface station 24 if desired.

For example, the limited communication module 50 may be implemented on a service server within the communication path of the network 26. The service server may be a within the service network provided by the service or instruction provider, such as at a remote service facility, or may be within the local network or intranet of the medical facility.

The limited communication module 50 may allow different limitations or security to be placed on the remotely accessible data. For example, one or more routines comprising the limited communication module 50 may be implemented on the service server or other platform at the medical facility that processes communication with the remote operator workstation 24. The limited communication module 50 may communicate with applications on the imaging station 10 and/or the remote operator workstation 24 via one or more specific communication interfaces, such as a Unix named pipe interface. The limited communication module 50 may act on the named pipe interface or other communication interface to effect control over what data is sent to and/or what data is received from the remote operator workstation 24.

For example, the limited communication module 50 may allow portions of the user display screen to be specified for monitoring or for modification when displayed remotely. Based on the graphical user interface (GUI) utilized by the software and control programs of the imaging system 10, portions of the display screen may be designated for modification, masking, monitoring, and so forth based on the selected communication pipe, i.e., local or remote connections. In particular, portions of the display screen corresponding to user interface elements, such as buttons, menu selections, sliders, and so forth, or data screens, such as patient name, may be so designated. For example, a limited command interface 51, typically local to the imaging system 10, may be present which allows an operator to designate user interface elements for special handling by the limited communication module 50. In this way, restricted user interface elements of the imaging system 10 may be designated at the limited command interface 51, allowing differential processing of the local and remote user interfaces by the limited communication module 50. The designation of the user interface elements at the limited command interface 51 may be by identification of particular pixels or Cartesian coordinates corresponding to a portion of the screen to be regulated. Alternatively, the restricted status may be a property of standardized objects, depending on the GUI employed, which may be set to restrict remote access.

The unique location or identifying designation of restricted objects, pixels, or screen locations, hereinafter referred to as interface regions, may thereby be established at the limited communication module 50 for differential handling of remote viewing and operations. In addition, where cascading screens may be employed or where parent screens may give rise to child screens, depending on the GUI employed, provision may be made in the limited communication module 50 for dynamically adjusting to accommodate for windows which are moved or rescaled. Similarly, functions or options in a child screen which are related to a restricted interface region in the parent screen may be configured to inherit the restrictions of the parent. In this manner, the protections provided by the limited communication module 50 may not be obviated or circumvented by moving or resizing a window of the GUI or by accessing a restricted function or data via a child window.

Examples of the types of differential handling that may be implemented by the limited communication module 50 include blocking and guarding functions. For example, blocking an interface region would prevent the display of the interface region on the remote operator workstation 24 and would prevent user action in the interface region, i.e., selecting or clicking on a masked button. Similarly, guarding an interface region would prevent user action in the interface region, however the contents of the guarded interface region may be visible to the remote operator. However, to allow a remote operator to know that an interface region is guarded, the guarded interface region may be visually differentiated, such as by differential coloring, tinting, brightness, patterning, hatching, shading, and so forth.

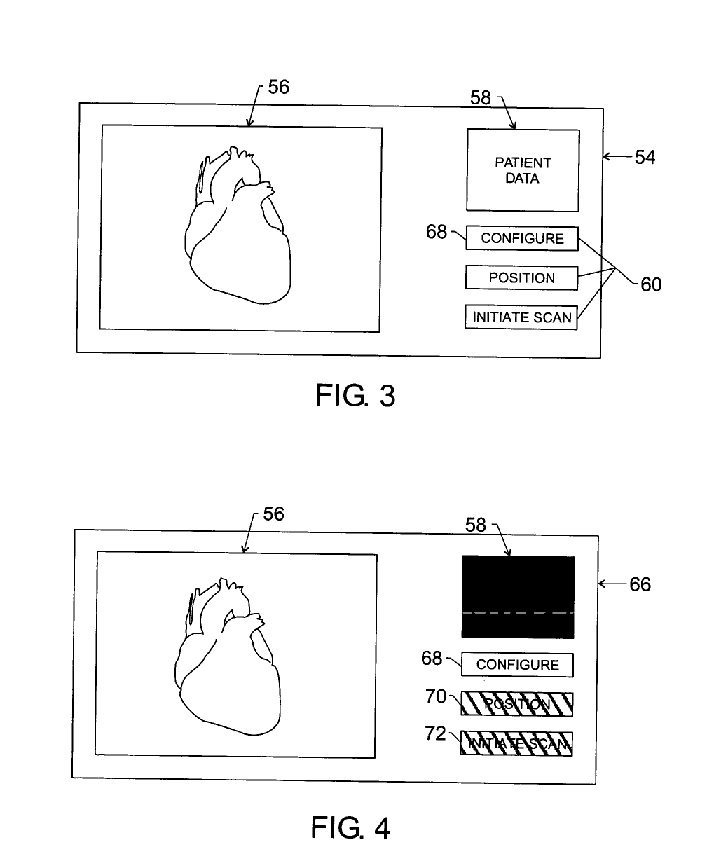

Returning to FIG. 2, an example of the implementation of a limited communication module 50 is provided. The imaging station 10, generates screen updates 52 that may be used to update the update the displayed information on the monitors 30 of both the local and remote operator workstations 22, 24. The local screen 54 comprises those screen updates 52 sent to a communications pipe directed to the local operator workstation 22. The local screen 54, as depicted in FIG. 3, may comprise a variety of interface regions, such as an image data region 56, a patient data region 58, and one or more operator selectable buttons 60.

The local screen 54 may be displayed on the local operator workstation 22 where a local operator may view the image or patient data regions 56, 58 or select one or more of the buttons 60. If the local operator interacts with the local operator workstation displaying the local screen to generate a response or command, one or more local user inputs 62 may be generated which may be relayed to the imaging system 10.

Conversely, the screen updates 52 sent to a communication pipe directed to a remote operator workstation 24 may be modified by the action of the limited communication module 50. In particular, the limited communication module 50 may apply blocks and guards to designated interface regions, as depicted at step 64, of the screen updates 52 to generate a remote screen 66. For example, referring to the remote screen 66 depicted in FIG. 4, the image data region 56 and the configuration button 68 have not been designated as interface regions to be guarded or blocked and therefore appear as they do on the local screen 54. The patient data region 58, however, has been designated as an interface region to be blocked remotely, and may, therefore, be displayed as a solid block or opaque region on the remote screen 66. Similarly, the position 70 and initiate scan 72 buttons have been designated as interface regions to be guarded remotely and may therefore be displayed with an overlying hatching or shading such that the remote operator may see the contents of the interface regions but knows that the functions are prohibited.

The remote screen 66, complete with guards and blocks, may be displayed on the remote operator workstation 24 for viewing or manipulation by the remote operator. The remote operator may interact with unguarded and unblocked interface regions of the remote screen 66 to generate remote user inputs 74 directed to the imaging system 10. The remote user inputs 74, however, may be filtered at step 76 based upon the communications pipe they arrive through, i.e., a communication pipe from a remote site. During the step of filtering, the limited communication module 50 may remove or eliminate remote inputs 74 which originated from a selection by the remote operator within a guarded or blocked interface region, such as position or scan buttons 70, 72. The resulting filtered inputs 78, i.e., selections originating from non-guarded and non-blocked interface regions, may then be provided to the imaging system 10.

Though the limited communication module 50 has been depicted as blocking and guarding interface regions sent to remote sites, it may also be used to block or guard interface regions sent to the local operator workstation 22. For example, it may be desirable to block or guard some interface regions in a complementary fashion, such that an interface region may not be simultaneously available for selection by both the local and remote users. In the present example, referring once again to FIG. 3, it may be desirable to present the configure button 68 as guarded on the local screen 54 to allow only the remote operator to configure the imaging system 10. In this manner, the remote operator may be able to configure the imaging system 10 but unable to position the system components or initiate the scan. The local operator, conversely, would be unable to configure the imaging system 10 but would be able to position the system components and to initiate the scan. Regardless of whether such a complementary implementation is employed, the present technique allows a remote operator, such as an engineer or technician, to remotely access the imaging system 10 in a controlled manner while preserving patient confidentiality and local control over the physical site.

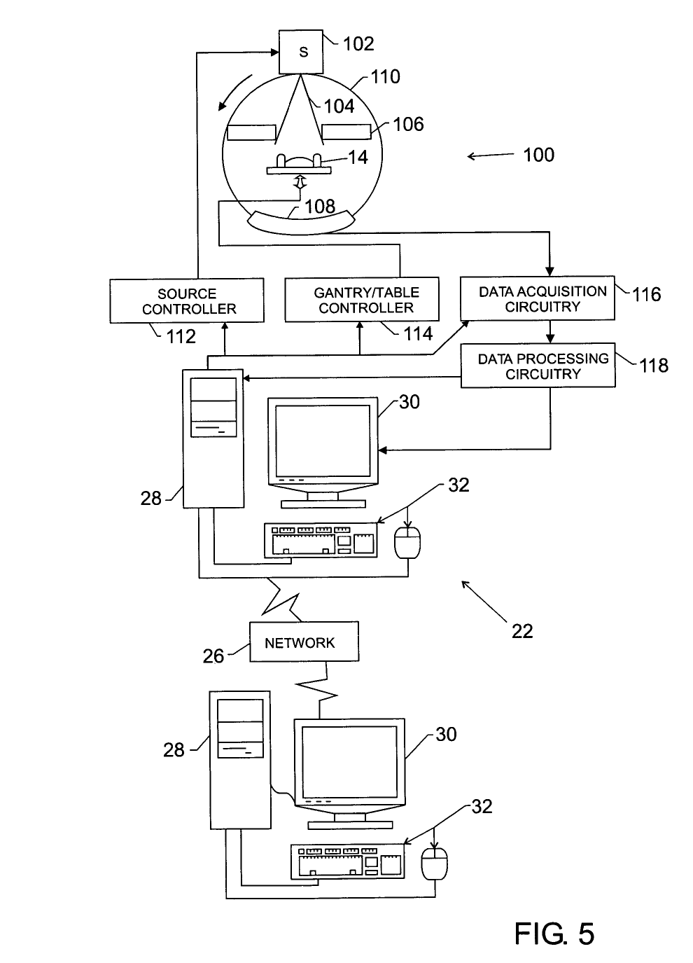

Though the present technique has been discussed in regard to general imaging technologies, one of ordinary skill in the art will readily appreciate how it may be adapted to specific imaging modalities. For example, the present technique may be applied to computed tomography (CT) systems to allow remote configuration and access to the imaging system while preventing remote movement of the gantry or patient table and remote activation of the X-ray source. Referring to FIG. 5, an exemplary computed tomography (CT) imaging system 100 that may utilize the present technique is depicted. As one of ordinary skill in the art will appreciate, the CT imaging system 100 includes a radiation source 102, which is configured to generate X-ray radiation in a fan or cone-shaped beam 104. A collimator 106 defines limits of the radiation beam. The radiation beam 104 is directed toward a detector 108 made up of an array of photodiodes and transistors which permit readout of charges of the diodes depleted by impact of the radiation from the source 102. Radiation source 102, collimator 106 and detector 108 may be mounted on a rotating gantry 110 that enables them to be rotated about a subject, typically at speeds approaching two or more rotations per second. Configurations of CT imaging systems 100 which differ from that depicted in FIG. 5 are also possible, as one of ordinary skill in the art will appreciate. For example, in some configurations detector 108 comprises a ring of detector elements that does not rotate. These and other alternative configurations, such as electron beam tomography (EBT), are well within the scope of the present techniques.

In the depicted configuration, the source 102 and detector 108 are rotated during an examination sequence, generating a series of view frames at angularly displaced locations around a patient 14 positioned within gantry 110. A number of view frames (e.g. between 500 and 1000) are collected for each rotation, and a number of rotations may be made, such as in a helical pattern as the patient 14 is slowly moved along the axial direction of the system 100. For each view frame, data is collected from individual pixel locations of detector 108 to generate a large volume of discrete data. A CT source controller 112 regulates operation of radiation source 102, while a gantry/table controller 114 regulates rotation of gantry 110 and control of movement of patient 14. As will be appreciated by one skilled in the art, in the described configuration, the CT source controller 112 and the gantry/table controller 114 comprise the system control circuitry 16 discussed in FIG. 1.

Data collected by detector 108 may be digitized and forwarded to data acquisition circuitry 116. Data acquisition circuitry 116 may perform initial processing of the data, such as for generation of a data file. The data file may incorporate other useful information, such as relating to cardiac cycles, positions within the system at specific times, and so forth. Data processing circuitry 118 then receives the data and performs a wide range of data manipulation and computations. In general, all or part of the data acquired by the CT scanner can be reconstructed into useful images in a range of manners known to one of ordinary skill in the art. In particular, reconstruction of the data into useful images typically includes computations of projections of radiation on detector 108 and identification of relative attenuations of the data by specific locations within patient 14. The raw, the partially processed, and the fully processed data may be forwarded for post-processing, storage and image reconstruction.

The data may be available immediately to an operator, such as at a local operator workstation 22, and may be transmitted remotely via network 26, such as to a remote operator workstation 24. Similarly configuration and operation commands and instructions may be provided to the source and gantry/table controllers 112, 114 via the local or remote operator interfaces 22, 24. As discussed herein, portions of the data transmitted to and instruction received from the remote operator workstation 24 may be guarded or blocked via a limited communication module 50 operating between the remote interface 24 and the respective components of the CT system 100. In particular, the activation of the source controller 112 and/or the gantry/table controller 114 may be blocked or guarded from remote operators in accordance with the present technique.

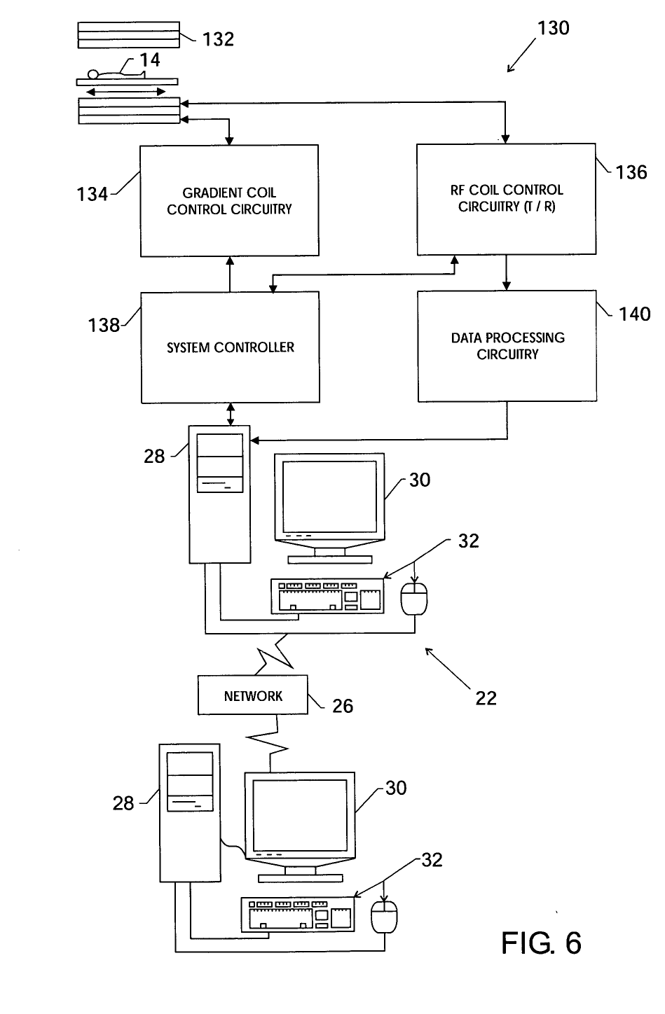

Another example of an imaging system 10 is a magnetic resonance imaging (MRI) system 130, represented diagrammatically in FIG. 6. The MRI system 130 includes an MR scanner 132 in which a patient 14 is positioned for acquisition of image data. The scanner 132 generally includes a primary magnet for generating a magnetic field that influences gyromagnetic materials within the patient's body. As the gyromagnetic material, typically water and metabolites, attempts to align with the magnetic field, gradient coils produce additional magnetic fields that are orthogonally oriented with respect to one another. The gradient fields effectively select a slice of tissue through the patient for imaging, and encode the gyromagnetic materials within the slice in accordance with phase and frequency of their rotation. A radio-frequency (RF) coil in the scanner generates high frequency pulses to excite the gyromagnetic material and, as the material attempts to realign itself with the magnetic fields, magnetic resonance signals are emitted which are collected by the radio-frequency coil.

The scanner 132 is coupled to gradient coil control circuitry 134 and to RF coil control circuitry 136. Gradient coil control circuitry 134 permits regulation of various pulse sequences that define imaging or examination methodologies used to generate the image data. Pulse sequence descriptions implemented via gradient coil control circuitry 134 are designed to image specific slices, anatomies, as well as to permit specific imaging of moving tissue, such as blood, and defusing materials. The pulse sequences may allow for imaging of multiple slices sequentially, such as for analysis of various organs or features, as well as for three-dimensional image reconstruction. RF coil control circuitry 136 permits application of pulses to the RF excitation coil, and serves to receive and partially process the resulting detected MR signals. It should also be noted that a range of RF coil structures may be employed for specific anatomies and purposes. In addition, a single RF coil may be used for transmission of the RF pulses, with a different coil serving to receive the resulting signals.

Gradient and RF coil control circuitries 134 and 136 function under the direction of an MR system controller 138. The MR system controller 138 implements pulse sequence descriptions that define the image data acquisition process. The MR system controller 138 will generally permit some amount of adaptation or configuration of the examination sequence by means of a local operator interface 22 or remote operator interface 24, in accordance with the technique described herein.

Data processing circuitry 140 receives the detected MR signals and processes the signals to obtain data for reconstruction. In general, the data processing circuitry 140 digitizes the received signals, and performs a two-dimensional fast Fourier transform on the signals to decode specific locations in the selected slice from which the MR signals originated. The resulting information provides an indication of the intensity of MR signals originating at various locations or volume elements (voxels) in the slice. Each voxel may then be converted to a pixel intensity in image data for reconstruction. Data processing circuitry 140 may perform a wide range of other functions, such as for image enhancement, dynamic range adjustment, intensity adjustments, smoothing, sharpening, and so forth. The resulting processed image data is typically forwarded to the local operator interface 22 for viewing, and/or for short or long-term storage.

As in the case of the foregoing imaging systems, MR image data may be viewed locally at a scanner location, or may be transmitted to remote locations, such as the remote operator interface 24, both within an institution and remote from an institution such as via network 26. In addition, configuration and operation commands and instructions may be provided to MR system controller 138 via the local or remote operator interfaces 22, 24. As discussed herein, a portion of the data transmitted to and instruction received from the remote interface 24 may be blocked or guarded via a limited communication module 50 operating between the remote interface 24 and the respective components of the MR system 130. In particular, remote operation of the gradient control circuitry 134 and/or RF control circuitry 136 may be blocked or guarded from remote operators in accordance with the present technique.

In addition to MR and CT systems, other medical imaging modalities may benefit from the present technique, as will be appreciated by one of ordinary skill in the art. For example, tomosynthesis, electron beam tomography (EBT), positron emission tomography (PET), and nuclear medicine systems may benefit from limited remote operator access for service or instruction. The movement of system components or the operation of the respective radiation sources, however, may be guarded or blocked in accordance with the present technique to limit remotely initiated actions.

The technique disclosed herein, however, is not limited to the specific applications described, but may be applied in other contexts as well. For instance, the technique may be employed with imaging devices outside the medical field, such as in part inspection, baggage inspection, and quality control. Indeed, the technique may be employed with any device that may benefit from the implementation of limited or regulated remote access, such as for training or service, in which certain functionalities of the device are to remain under local control.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for limiting remote display of a local system user interface, comprising:
designating one or more interface regions of a system user interface as limited remote access interface regions;
modifying the limited remote access interface regions present in screen data sent to a remote operator workstation for display; and
displaying the modified interface regions at the remote operator workstation, wherein the modified interface regions visually differ when displayed from respective unmodified interface regions.

2. The method as recited in claim 1, wherein each limited remote access regions is designated with one of two or more levels of remote access corresponding to different degrees of modification such that the differentially modified interface regions may be visually distinguished when displayed at the remote operator workstation.

3. The method as recited in claim 2, wherein one level of remote access corresponds to a modified interface region comprising a solid visual region when displayed such that no text or image is visible.

4. The method as recited in claim 2, wherein one level of remote access corresponds to a modified interface region comprising a visually obscured region when displayed through which text or images may be visible.

5. The method as recited in claim 4, wherein the visually obscured region comprises one or more of a hatching, a shading, and a tinting.

6. The method as recited in claim 1, wherein the system user interface comprises a medical imaging system user interface.

7. A method for limiting remote operation of a local system user interface, comprising:
designating one or more interface regions of a system user interface as limited remote access interface regions;
identifying one or more restricted remote inputs in an input stream to a local system using the system user interface, wherein the one or more restricted remote inputs are generated via interaction at a remote operator workstation with the one or more limited remote access interface regions; and
removing the one or more restricted remote inputs from the input stream to the local system.

8. The method as recited in claim 7, wherein each limited remote access region is designated with one of two or more levels of remote access.

9. The method as recited in claim 7, wherein the system user interface comprises a medical imaging system user interface and the local system comprises a medical imaging system.

10. A computer program, provided on one or more computer readable media, for limiting remote display of a local system user interface, comprising:
a routine for designating one or more interface regions of a system user interface as limited remote access interface regions; and
a routine for modifying the limited remote access interface regions present in screen data sent to a remote operator workstation for display, wherein the modified interface regions visually differ from respective unmodified interface regions when displayed.

11. The computer program as recited in claim 10, wherein the routine for designating designates each limited remote access region with one of two or more levels of remote access and wherein the routine for modifying modifies each limited remote access region based upon the designated level of remote access such that the differentially modified interface regions may be visually distinguished when displayed at the remote operator workstation.

12. The computer program as recited in claim 11, wherein the routine for modifying modifies each interface region designated with a first level of remote access such that the modified interface regions comprise a solid visual region when displayed such that no text or image is visible.

13. The computer program as recited in claim 11, wherein the routine for modifying modifies each interface region designated with a first level of remote access such that the modified interface regions comprise a visually obscured region when displayed through which text or images may be visible.

14. The computer program as recited in claim 13, wherein the visually obscured region comprises one or more of a hatching, a shading, and a tinting.

15. The computer program as recited in claim 10, wherein the system user interface comprises a medical imaging system user interface.

16. A computer program, provided on one or more computer readable media, for limiting remote operation of a local system user interface, comprising:
a routine for designating one or more interface regions of a system user interface as limited remote access interface regions;
a routine for identifying one or more restricted remote inputs in an input stream to a local system using the system user interface, wherein the one or more restricted remote inputs are generated via interaction at a remote operator workstation with the one or more limited remote access interface regions; and
a routine for removing the one or more restricted remote inputs from the input stream to the local system.

17. The computer program as recited in claim 16, wherein the routine for designating designates each limited remote access region with one of two or more levels of remote access.

18. The computer program as recited in claim 16, wherein the system user interface comprises a medical imaging system user interface and the local system comprises a medical imaging system.

19. A remote viewing system for a medical imaging system, comprising:
a local medical imaging system, comprising:
an imager configured to detect one or more signals which may be converted into a physiological image;
one or more data acquisition circuits configured to receive and process the one or more signals from the imager;
one or more system control circuits configured to control one or more of the imager and the data acquisition circuits;
at least one local operator workstation configured to receive at least the one or more processed signals and to communicate with the one or more system control circuits and with one or more memory devices;
a remote operator workstation configured to receive at least the one or more processed signals via a network connection; and
a limited communication module located on at least one of the network connection and the local medical imaging system, wherein the limited communication module may be configured to designate one or more interface regions of a system user interface as limited remote access interface regions and to modify the limited remote access interface regions present in screen data sent to the remote operator workstation such that the modified interface regions visually differ from the respective unmodified interface regions when displayed.

20. The remote viewing system as recited in claim 19, further comprising one or more data processing circuits configured receive and further process the one or more signals from the one or more data acquisition circuits.

21. The remote viewing system as recited in claim 19, wherein the local medical imaging system comprises one of a CT imaging system, an MRI imaging system, a tomosynthesis system, an EBT imaging system, a PET imaging system, and a digital X-ray imaging system.

22. The remote viewing system as recited in claim 19, wherein the limited communication module comprises routines executed on at least one of the system control circuits and the local operator workstation.

23. The remote viewing system as recited in claim 19, wherein the limited communication module comprises routines executed by at least one server in the network connection.

24. The remote viewing system as recited in claim 19, wherein the limited communication module designates each limited remote access region with one of two or more levels of remote access and modifies each limited remote access region based upon the designated level of remote access such that the differentially modified interface regions may be visually distinguished when displayed at the remote operator workstation.

25. The remote viewing system as recited in claim 24, wherein the limited communication module modifies each interface region designated with a first level of remote access such that the modified interface regions comprise a solid visual region when displayed such that no text or image is visible.

26. The remote viewing system as recited in claim 24, wherein the limited communication module modifies each interface region designated with a first level of remote access such that the modified interface regions comprise a visually obscured region when displayed through which text or images may be visible.

27. The remote viewing system as recited in claim 26, wherein the visually obscured region comprises one or more of a hatching, a shading, and a tinting.

28. A remote input system for a medical imaging system, comprising:
a local medical imaging system, comprising:
an imager configured to detect one or more signals which may be converted into a physiological image;
one or more data acquisition circuits configured to receive and process the one or more signals from the imager;
one or more system control circuits configured to control one or more of the imager and the data acquisition circuits;
at least one local operator workstation configured to receive at least the one or more processed signals and to communicate with the one or more system control circuits and with one or more memory devices;
a remote operator workstation configured to receive at least the one or more processed signals and to communicate with the one or more system control circuits via a network connection; and
a limited communication module located on at least one of the network connection and the local medical imaging system, wherein the limited communication module may be configured to designate one or more interface regions of a system user interface as limited remote access interface regions, to identify one or more restricted remote inputs in an input stream to the local medical imaging system using the system user interface, wherein the one or more restricted remote inputs are generated via interaction at the remote operator workstation with the one or more limited remote access interface regions, and to remove the one or more restricted remote inputs from the input stream to the local medical imaging system.

29. The remote input system as recited in claim 28, further comprising one or more data processing circuits configured receive and further process the one or more signals from the one or more data acquisition circuits.

30. The remote input system as recited in claim 28, wherein the local medical imaging system comprises one of a CT imaging system, an MRI imaging system, a tomosynthesis system, an EBT imaging system, a PET imaging system, and a digital X-ray imaging system.

31. The remote input system as recited in claim 28, wherein the limited communication module comprises routines executed on at least one of the system control circuits and the local operator workstation.

32. The remote input system as recited in claim 28, wherein the limited communication module comprises routines executed by at least one server in the network connection.

33. The remote input system as recited in claim 28, wherein the limited communication module designates each limited remote access region with one of two or more levels of remote access.

34. A remote viewing system for a medical imaging system, comprising:
a local medical imaging system, comprising:
an imager configured to detect one or more signals which may be converted into a physiological image;
one or more data acquisition circuits configured to receive and process the one or more signals from the imager;
one or more system control circuits configured to control one or more of the imager and the data acquisition circuits;
at least one local operator workstation configured to receive at least the one or more processed signals and to communicate with the one or more system control circuits and with one or more memory devices;
a remote operator workstation configured to receive at least the one or more processed signals via a network connection; and
means for visually limiting a user interface displayed on the remote operator workstation relative to the user interface displayed on the local operator workstations.

35. A remote input system for a medical imaging system, comprising:
a local medical imaging system, comprising:
an imager configured to detect one or more signals which may be converted into a physiological image;
one or more data acquisition circuits configured to receive and process the one or more signals from the imager;
one or more system control circuits configured to control one or more of the imager and the data acquisition circuits;
at least one local operator workstation configured to receive at least the one or more processed signals and to communicate with the one or more system control circuits and with one or more memory devices;
a remote operator workstation configured to receive at least the one or more processed signals and to communicate with the one or more system control circuits via a network connection; and
means for limiting the communication from the remote operator workstation to the one or more control circuits.
